(19) United States
(12) Patent Application Publication
(10) Pub. No.: US 2007/0001564 A1
(43) Pub. Date: Jan. 4, 2007

(54) Light emitting diode package in backlight unit for liquid crystal display device

(75) Inventor: Hee Jeong Park, Gyeonggi-do (KR)

Correspondence Address: JENKENS & GILCHRIST, P.C., 901 15TH STREET N.W., SUITE 900, WASHINGTON, DC, 20005, US

(73) Assignee: LG.PHILIPS LCD CO., LTD., Seoul (KR)

(21) Appl. No.: 11/455,708

(22) Filed: Jun. 20, 2006

(30) Foreign Application Priority Data
Jun. 30, 2005 (KR) 10-2005-0058390

(51) Int. Cl. H01J 1/62; H01J 63/04

(52) U.S. Cl. 313/46; 313/512

(57) ABSTRACT

A light emitting diode package includes an electrode pattern over a substrate, an electrode adhesive on the electrode pattern, a heat dissipating layer over the substrate, a body part abutting the heat dissipating layer, a light emitting diode chip on the body part, and a terminal part connected to the light emitting diode chip and attached to the electrode adhesive.

The present invention claims the benefit of Korean Patent Application No. P2005-058390 filed in Korea on Jun. 30, 2005, which is hereby incorporated by reference in its entirety.

### BACKGROUND OF THE INVENTION

1. Field of the Invention

The present invention relates to a display device, and more particularly, to a light emitting diode (LED) package in a backlight unit for a liquid crystal display (LCD) device. Although the present invention is suitable for a wide scope of applications, it is particularly suitable for improving the performance of a backlight unit.

2. Description of the Related Art

An LCD includes a liquid crystal panel, a driving unit, and a backlight unit. The liquid crystal panel includes a top glass substrate, a bottom glass substrate, and a liquid crystal layer interposed between the top and bottom glass substrates. When a predetermined voltage is applied to electrodes respectively formed on the top and bottom glass substrates, the direction of the liquid crystal molecules in the liquid crystal layer is changed so as to display an image. Unlike a cathode ray tube (CRT), a plasma display panel (PDP) or a field emission display (FED), the LCD requires an external light source because the liquid crystal panel is a non-luminous device. Accordingly, a backlight assembly is provided with an LCD to uniformly project light on the liquid crystal panel.

Backlight assemblies are classified into direct type and side type backlight assemblies according to the position of a lamp in the backlight assembly. The direct type backlight assembly includes a lamp disposed at a rear surface of the liquid crystal panel so as to directly project light through the liquid crystal panel. The side type backlight assembly includes a lamp disposed at a side of the liquid crystal panel and projects light into a light guide plate, and the light is redirected and distributed to go through the liquid crystal display panel.

Examples of a backlight assembly lamp are an electroluminescent (EL) lamp, a light emitting diode (LED), and a cold cathode fluorescence lamp (CCFL). The LED is widely used as a light source in the backlight assembly of the LCD. Further, the LED is more durable than the CCFL, and does not require an inverter to provide an AC supply voltage because the LED operates at 5V DC. However, a current control circuit is required to protect the LED.

The related art backlight unit for the LCD and a method of fabricating the same will be described with reference to FIGS. 1 and 2. FIG. 1 is a cross-sectional view of the related art LCD device. As illustrated in FIG. 1, the LCD device includes a liquid crystal panel 10 for displaying an image, a backlight unit 14 providing light. The backlight unit 14 includes a plurality of LEDs 15 for emitting light, a reflecting plate 12 for reflecting light toward the liquid crystal panel 10, and an optical sheet 11 for diffusing the light uniformly. The LEDs 15 may be three primary colors (red (R), green (G) and blue (B)) of LEDs or a white light (W) LED. In addition, the LCD with the LEDs 15 includes a substrate 13 with circuitry for controlling current to the LEDs 15 from a power source.

The optical sheet 11 is spaced apart from the LEDs 15 to prevent images of the LEDs 15 from being seen on the liquid crystal panel 10. In the related art LCD, the light emitted from the LEDs 15 is provided to the liquid crystal panel 10 through the optical sheet 11. The optical sheet 11 can include a plurality of optical films.

FIG. 2 is a cross-sectional view of an LED package in the LCD device of FIG. 1. As shown in FIG. 2, the LED package 50 includes a substrate 33 with current control circuitry, an insulation layer 32 formed on the substrate 33, an electrode pattern 28 formed on the insulation layer 32, a predetermined space 29 preventing an electrical interference between the electrode patterns 28, and a heat conductive adhesive 30 attached to the top of the electrode pattern 28 on which the body part 24 is mounted, terminal parts 25 extending from both sides of the body part 24 into the predetermined space 29, a light emitting chip 21 affixed to the top of the body part 24, a silicone 22 on the top of the light emitting chip 21 for adjusting light transmissivity, a plastic lens 23 surrounding the silicone 22 and affixed to the body part 24. Further, the LED package 50 includes an electrode adhesive 27 and a terminal adhesive 26 to connect the terminal part 25 to the electrode pattern 28.

In a method of fabricating the related art LED package, the insulation layer 32 is formed on the substrate 33, and the electrode pattern 28 is formed on the insulation layer 32 to apply electric signals to a subsequently mounted light emitting chip 21. The predetermined space 29 is formed through an etching process of the electrode patterns 28. The predetermined space 29 prevents electrical interference.

Next, the heat conductive adhesive 30 is attached to the top of the electrode pattern 28, and then the body part 24 is mounted on the heat conductive adhesive 30. Subsequently, the electrode adhesive 27 and the terminal adhesive 26 are mounted on an electrode pattern region to which the terminal part 25 extending from the body part 24 is to be connected. The terminal part 25 is connected to the electrode pattern 28 using a soldering process.

In the related art LED package 50, a deformation of the plastic lens 23 and the silicone 22 occurs frequently because of a low heat transmissivity of the heat conductive adhesive 30 when the terminal part 25 is connected to the electrode pattern 28 using a soldering process. In other words, the heat of the soldering is not transferred to the substrate 33 through the heat conductive adhesive 30 but rather accumulates in the body part 24 and thus deforms deformation of the plastic lens 23 and the silicone 22. Since light intensity is degraded by the deformed silicone 22 and the plastic lens 23, image quality is deteriorated because of a non-uniform brightness.

### SUMMARY OF THE INVENTION

Accordingly, the present invention is directed to an LED package and a method of fabricating the same, a backlight using the same, and an LCD that substantially obviate one or more problems due to limitations and disadvantages in the related art.

An object of the present invention is to maximize a heat dissipation.

Another object of the present invention is to prevent deformation of the plastic lens and the silicone over the light emitting chip in the light emitting package.

Another object of the present invention is to provide a backlight unit for an LCD with improved light efficiency.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a light emitting diode package includes an electrode pattern over a substrate, an electrode adhesive on the electrode pattern, a heat dissipating layer over the substrate, a body part abutting the heat dissipating layer, a light emitting diode chip on the body part, and a terminal part connected to the light emitting diode chip and attached to the electrode adhesive.

In another aspect of the present invention, there is provided a method of fabricating a light emitting diode package that includes abutting a body part with a light emitting diode chip and a terminal part against a heat dissipating layer such that the heat dissipating layer conforms to a surface of the body part, forming an electrode pattern on a substrate, soldering the electrode pattern and the terminal part, and combining a lens with a top of the body part.

In another aspect of the present invention, there is provided a backlight unit including a light emitting diode package including an electrode pattern over a substrate, an electrode adhesive on the electrode pattern, a heat dissipating layer over the substrate, a body part abutting the heat dissipating layer, a light emitting diode chip on the body part, and a terminal part connected to the light emitting diode chip and attached to the electrode adhesive, and a light diffusion unit for diffusing light generated from the light emitting diode package.

In a still further another aspect of the present invention, there is provided a liquid crystal display device including first and second substrates, a liquid crystal panel having a liquid crystal layer formed between the first and second substrates, and a backlight unit for projecting light to the liquid crystal panel, wherein the backlight unit includes: a light emitting diode package including an electrode pattern over a substrate, an electrode adhesive on the electrode pattern, a heat dissipating layer over the substrate, a body part abutting the heat dissipating layer, a light emitting diode chip on the body part, and a terminal part connected to the light emitting diode chip and attached to the electrode adhesive; and a light diffusion unit for diffusing light generated from the light emitting diode package.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is cross-sectional view of a related art LCD device;

FIG. 2 is a detailed cross-sectional view of an LED package in the LCD device of FIG. 1;

FIGS. 3a to 3f are cross-sectional views of a method of fabricating an LED package for a liquid crystal display panel according to one embodiment of the present invention;

FIGS. 4a to 4f are cross-sectional views of a method of fabricating an LED package for a liquid crystal display panel according to another embodiment of the present invention; and

FIGS. 5 and 6 are cross-sectional views of a heat dissipating layer in an LED package according to another embodiment of the present invention.

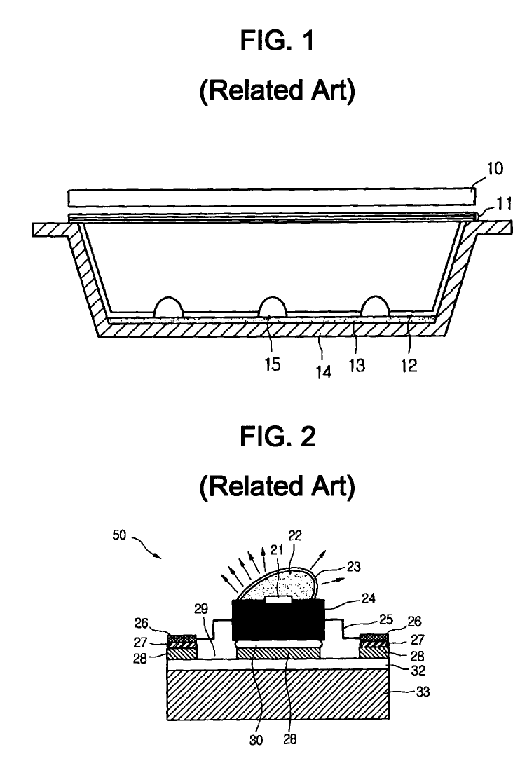

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

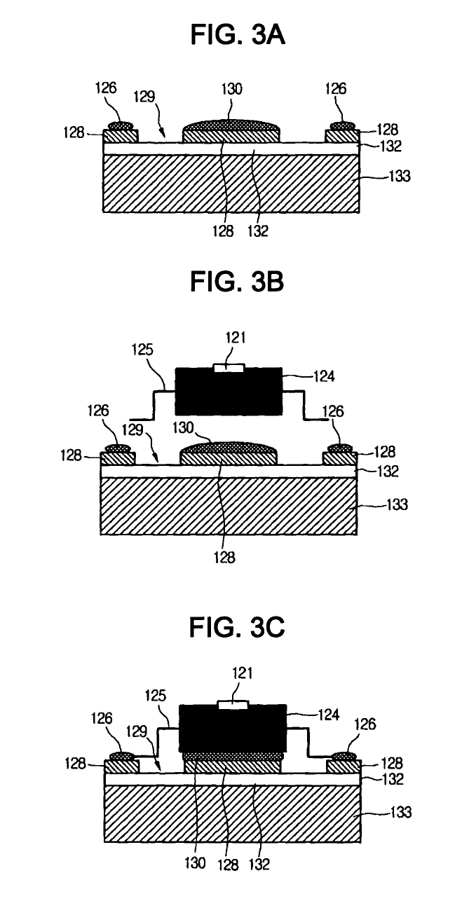

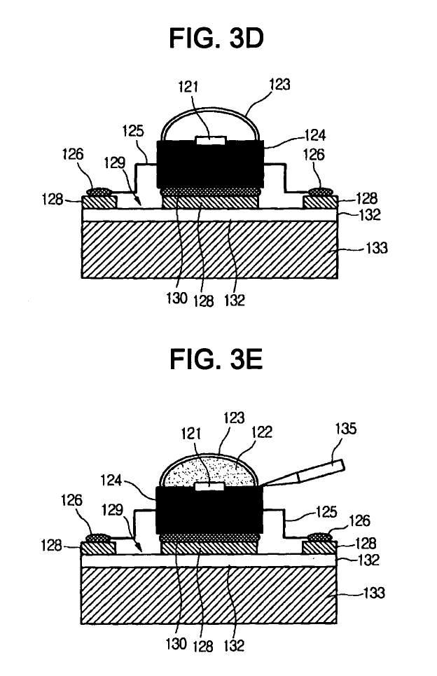

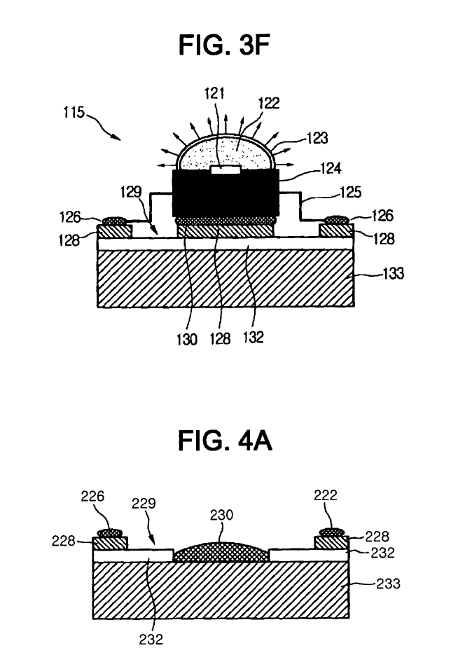

FIGS. 3a to 3f are cross-sectional views of a method of fabricating an LED package for a liquid crystal display panel according to one embodiment of the present invention. As illustrated in FIG. 3a, an LED package includes a substrate 133 of a ceramic material, an insulation layer 132 on top of the substrate 133, an electrode pattern 128 with a predetermined spaces 129 on top of the insulation layer 132, and a heat dissipating layer 130 and an electrode adhesive 126 on top of the electrode pattern 128. The ceramic material can be alumina because alumina has an excellent thermal resistance, chemical resistance, mechanical strength, and low-dissipation discharge.

The insulation layer 132 protects LEDs from external physical and chemical corrosion and is formed of a transparent material. An epoxy or a transparent resin of Si series can be used as the transparent material for the insulation layer 132. Moreover, the transparent material should be an excellent heat conductor to maximize heat dissipation.

In a fabricating process, the insulation layer 132 is formed on the substrate 133. An electrode pattern 128 is then formed by a patterning process after a metal layer is formed on the insulation layer 132. The electrode patterns 128 are spaced at predetermined intervals to have predetermined spaces 129 between each other to prevent an electrical interference and a short circuit. Subsequently, the heat dissipating layer 130 is formed on a predetermined region of the insulation layer 132 on the substrate 133 to improve heat dissipation. Additionally, the electrode adhesive 126 is formed on each of the other electrode patterns 128.

The heat dissipating layer 130 and the electrode adhesive 126 can be formed of the same material, such as a soldering material. Examples of the soldering material are a solder paste with a lead and a solder paste without a lead (including a tartar series metal). Alternatively, the heat dissipating layer 130 and the electrode adhesive 126 can be respectively formed of different materials. The electrode adhesive 126 can be formed of the soldering material while the heat dissipating layer 130 can be formed of an anisotropic conductive film (ACF) and a paste with conductive balls.

As illustrated in FIGS. 3b and 3c, the electrode adhesive 126 is formed on the electrode pattern 128. As shown in FIG. 3b, the body part 124 with the light emitting chip 121 is disposed on the heat dissipating layer 130 so that the heat dissipating layer 130 abuts the body part 124 without physically connecting to the body part 124. Thus, the body part 124 with the light emitting chip 121 is disposed on the heat dissipating layer 130 while the terminal part 125 is provided on the electrode patterns 128 spaced apart from the electrode pattern 128 on which the body part 124 is disposed.

In a method of the mounting the body part 124, the body part 124 is disposed to abut the heat dissipating layer 130 such that the bottom of the body part 124 can conduct heat through the heat dissipating layer 130, and the terminal part 125 extending from both sides of the body part 124 contacts electrode adhesive 126 by a soldering process at a temperature greater than 100° C. As shown in FIG. 3c, the heat dissipating layer 130 conforms to a surface of the body part 124 in response to the body part 124 being abutted against the heat dissipating layer 130. Thus, heat from the terminal part 125 is transmitted in to the body part 124, and then the transmitted heat is dissipated through the heat dissipating layer 130 to the substrate 133, which then further dissipates the heat from the terminal part 125. Heat generated in the body part 124 can also be dissipated through the heat dissipating layer 130 to the substrate 133, which then further dissipates the heat from the body part 124.

As illustrated in FIG. 3d, after the soldering process, the plastic lens 123 is attached to the body part 124. Since the heat generated from the soldering process is previously dissipated through the heat dissipating layer 130 abutting the body part 124, the plastic lens 123 maintains its shape. Further, the plastic lens maintains its shape during subsequent operations because heat from the light emitting chip 121 is dissipated through the heat dissipating layer 130 abutting the body part 124. The plastic lens 123 can be attached to the body part 124 with an epoxy adhesive.

As illustrated in FIG. 3e, a small hole (not shown) is then formed on one side of the plastic lens 123 to inject a filling material, such as silicone or epoxy, in the plastic lens 123. An injector 135 is used to inject the filling material through the hole. The filling material injected into the plastic lens 123 is hardened by light or heat through a curing process. Thus, no additional encapsulating process is necessary for addressing the hole in the plastic lens 123.

As illustrated in FIG. 3f, the LED package 115 is ready for operation. The heat dissipating layer 130 abutted against the body part 124 provides a heat conductive path to an underlying portion of an electrode pattern 128, which is attached to the substrate 133 and transfers heat to the substrate 133. Thus, the heat generated from the light emitting chip 121 or a soldering process of the terminal part 125 extending from both sides of the body part 124 can be dissipated via the body part 124 through the heat dissipating layer 130. Deformation of the silicone 122 and the plastic lens 123 can be prevented during subsequent operation of the light emitting chip 121.

Since the heat from the LEDs can be effectively dissipated to the substrate, the LEDs can be assembled together at a high-density and over a large area. Thus, the LED package with the heat dissipating layer has a high heat efficiency, which enables more LEDs to increase light output. Thus, an LED package with more LEDs can be used as a backlight for providing light to a liquid crystal display panel with a color filter substrate and a thin film transistor substrate. The light is provided to the liquid crystal panel through a light diffusion unit on top of the LED package in the backlight unit.

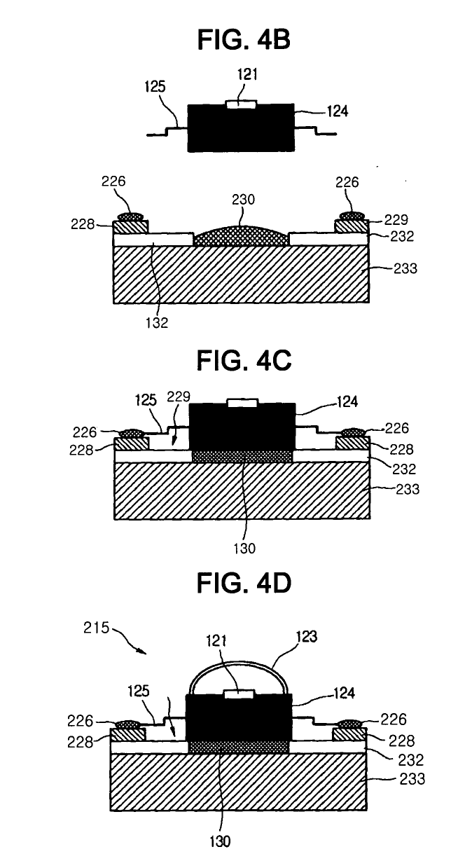

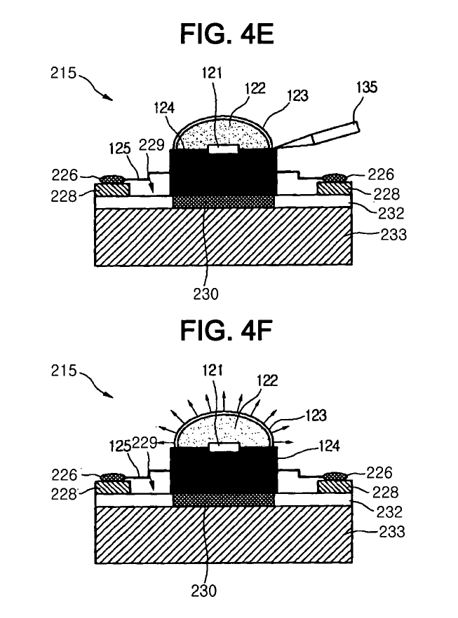

FIGS. 4a to 4f are cross-sectional views of a method of fabricating an LED package for a liquid crystal display panel according to another embodiment of the present invention. As illustrated in FIG. 4a, an LED package includes a substrate 233 of a ceramic material, an insulation layer 232 with an opening on top of the substrate 233, a heat dissipating layer 230 in the opening of the insulation layer, an electrode pattern 228 with a predetermined space 229 on top of the insulation layer 232, and an electrode adhesive 226 on top of the electrode pattern 228. The ceramic material can be alumina because alumina has an excellent thermal resistance, chemical resistance, mechanical strength, and low-dissipation discharge.

In a fabricating process, the insulation layer 232 is formed on the substrate 233. A portion of the insulation layer 232 is then selectively removed using an etching mask, such as a photoresist pattern, to form an opening in the insulation layer 232. An electrode pattern 228 is then formed by a patterning process after a metal layer is formed on the insulation layer 232. The electrode patterns 228 are spaced at a predetermined interval to have predetermined space 229 between each other to prevent an electrical interference and a short circuit. In the alternative, the opening in the insulation layer 232 can be formed after the formation of the electrode patterns 228. Subsequently, the heat dissipating layer 230 is formed in the opening of the insulation layer 232 and directly on the substrate 133 to improve heat dissipation. Further, the electrode adhesive 226 is formed on each of the electrode patterns 228.

The heat dissipating layer 230 and the electrode adhesive 226 can be formed of the same material, such as a soldering material. Examples of the soldering material are a solder paste with a lead and a solder paste without a lead (including a tartar series metal). Alternatively, the heat dissipating layer 230 and the electrode adhesive 226 can be respectively formed of different materials. The electrode adhesive 226 can be formed of the soldering material while the heat dissipating layer 230 can be formed of an anisotropic conductive film (ACF) and a paste with conductive balls.

As illustrated in FIGS. 4b and 4c, the electrode adhesive 226 is formed on the electrode pattern 228. As shown in FIG. 3b, the body part 124 with the light emitting chip 121 is disposed on the heat dissipating layer 230 so that the heat dissipating layer 230 abuts the body part 124. Thus, the body part 124 with the light emitting chip 121 is disposed on the heat dissipating layer 130 while the terminal part 125 is provided on the electrode patterns 228 spaced apart from the body part 124.

In a method of the mounting the body part 124, the body part 124 is disposed to abut the heat dissipating layer 230 such that the bottom of the body part 124 can conduct heat through the heat dissipating layer 230 directly to the substrate 233, and the terminal part 125 extending from both sides of the body part 124 contacts the electrode adhesive 226 by a soldering process at a temperature greater than 100° C. As shown in FIG. 4c, the heat dissipating layer 230 conforms to a surface of the body part 124 in response to the body part 124 being abutted against the heat dissipating layer 230. Thus, heat from the terminal part 125 is transmitted into the body part 124, and then the transmitted heat is dissipated through the heat dissipating layer 130 to the substrate 233, which then further dissipates the heat from the terminal part 125. Heat generated in the body part 124 can also be dissipated through the heat dissipating layer 230 directly to the substrate 233, which then further dissipates the heat from the body part 124.

As illustrated in FIG. 4d, after the soldering process, the plastic lens 123 is attached to the body part 124. Since the heat generated from the soldering process is previously dissipated through the heat dissipating layer 230 abutting the body part 124, the plastic lens 123 maintains its shape. Further, the plastic lens 123 maintains its shape during subsequent operations of the light emitting chip 121 because heat from the light emitting chip 121 is dissipated through the heat dissipating layer 230 abutting the body part 124. The plastic lens 123 can attached to the body part 124 with an epoxy adhesive.

As illustrated in FIG. 4e, a small hole (not shown) is then formed on one side of the plastic lens 123 to inject a filling material, such as silicone or epoxy, in the plastic lens 123. An injector 135 is used to inject the filling material through the hole. The filling material injected into the plastic lens 123 is hardened by light or heat through a curing process. Thus, no additional encapsulating process is necessary for addressing the hole in the plastic lens 123.

As illustrated in FIG. 4f, the LED package 215 is ready for operation. The heat dissipating layer 230 abutted against the body part 124 provides a heat conductive path directly to the substrate 233. Thus, the heat generated from the light emitting chip 121 or a soldering process of the terminal part 125 extending from both sides of the body part 124 can be dissipated via the body part 124 through the heat dissipating layer 230. Deformation of the silicone 122 and the plastic lens 123 can be prevented during subsequent operation of the light emitting chip 121.

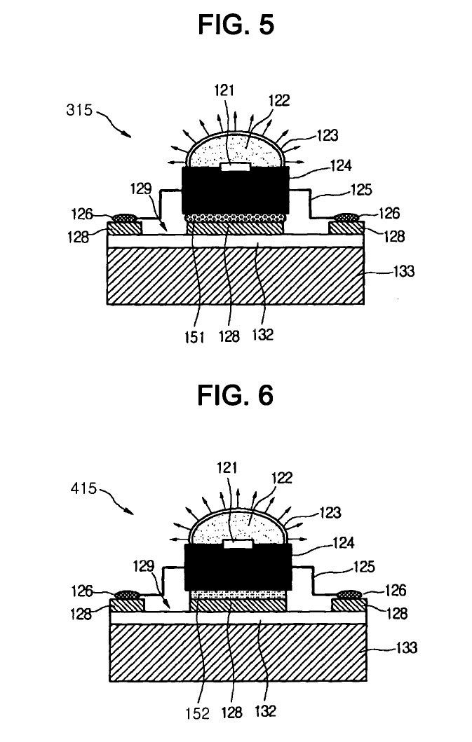

FIGS. 5 and 6 are cross-sectional views of a heat dissipating layer in an LED package according to other embodiments of the present invention. Referring to FIG. 5, the heat dissipating layer 151 in the LED package 315 is formed of a paste containing conductive balls such that the body part 124 abuts the paste containing conductive balls. Referring to FIG. 6, the heat dissipating layer 152 in the LED package 415 is formed of an anisotropic conductive film such that the body part 124 abuts the anisotropic conductive film.

As described above, a heat dissipating layer with excellent heat conductivity is provided between the body part and the substrate such that heat from the light emitting chip and/or a soldering process can be dissipated through the heat dissipating layer 130. More specifically, the heat dissipating layer abuts the body part of an LED package. Further, deformation of the silicone and the plastic lens can be prevented.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A light emitting diode package comprising:
an electrode pattern over a substrate;
an electrode adhesive on the electrode pattern;
a heat dissipating layer over the substrate;
a body part abutting the heat dissipating layer;
a light emitting diode chip on the body part; and
a terminal part connected to the light emitting diode chip and attached to the electrode adhesive.

2. The light emitting diode package according to claim 1, further comprising an insulation layer between the substrate and the electrode pattern.

3. The light emitting diode package according to claim 2, wherein the heat dissipating layer contacts the substrate.

4. The light emitting diode package according to claim 1, wherein the electrode adhesive is a soldering material.

5. The light emitting diode package according to claim 1, wherein the heat dissipating layer includes one of a soldering material, a conductive film, and a conductive ball paste.

6. The light emitting diode package according to claim 4, wherein the soldering material includes lead.

7. The light emitting diode package according to claim 1, wherein the substrate includes ceramic.

8. The light emitting diode package according to claim 7, wherein the ceramic includes alumina.

9. The light emitting diode package according to claim 1, further comprising:
a lens surrounding the light emitting diode chip; and
a filling material filling an inside of the lens.

10. A method of fabricating a light emitting diode package, comprising:
abutting a body part with a light emitting diode chip and a terminal part against a heat dissipating layer such that the heat dissipating layer conforms to a surface of the body part;
forming an electrode pattern on a substrate;
soldering the electrode pattern and the terminal part; and
combining a lens with a top of the body part.

11. The method according to claim 10, wherein the heat dissipating layer contacts the substrate.

12. The method according to claim 10, further comprising forming an insulation layer on the substrate.

13. The method according to claim 12, wherein the insulation layer has a removed portion corresponding to the body part to expose the substrate.

14. The method according to claim 12, wherein the portion of the insulation layer is removed using an etching process or a polishing process.

15. The method according to claim 12, wherein the insulation layer is selectively removed to print on the substrate.

16. The method according to claim 10, wherein the heat dissipating layer is formed of one of a soldering material, a conductive film, and a conductive ball paste.

17. The method according to claim 10, wherein the substrate includes ceramic.

18. The method according to claim 17, wherein the ceramic includes alumina.

19. A backlight unit comprising:
a light emitting diode package including an electrode pattern over a substrate, an electrode adhesive on the electrode pattern, a heat dissipating layer over the substrate, a body part abutting the heat dissipating layer, a light emitting diode chip on the body part, and a terminal part connected to the light emitting diode chip and attached to the electrode adhesive; and
a light diffusion unit for diffusing light generated from the light emitting diode package.

20. The backlight unit according to claim 19, further comprising an insulation layer between the substrate and the electrode pattern.

21. The backlight unit according to claim 20 wherein the insulation layer has a removed portion to expose the substrate.

22. The backlight unit according to claim 19, wherein the heat dissipating layer contacts the substrate.

23. The backlight unit according to claim 19, wherein the electrode adhesive is a soldering material.

24. The backlight unit according to claim 19, wherein the heat dissipating layer includes one of a soldering material, a conductive film, and a conductive ball paste.

25. The backlight unit according to claim 19, wherein the substrate includes ceramic.

26. The backlight unit according to claim 19, further comprising:
a lens surrounding the light emitting diode chip; and
a filling material filling an inside of the lens.

27. A liquid crystal display device comprising:
first and second substrates;
a liquid crystal panel having a liquid crystal layer formed between the first and second substrates; and
a backlight unit for projecting light to the liquid crystal panel,
wherein the backlight unit includes:
a light emitting diode package including an electrode pattern over a substrate, an electrode adhesive on the electrode pattern, a heat dissipating layer over the substrate, a body part abutting the heat dissipating layer, a light emitting diode chip on the body part, and a terminal part connected to the light emitting diode chip and attached to the electrode adhesive; and
a light diffusion unit for diffusing light generated from the light emitting diode package.

28. The liquid crystal display according to claim 27, further comprising an insulation layer between the substrate and the electrode pattern.

29. The liquid crystal display according to claim 28, wherein the insulation layer has a selectively removed portion.

30. The liquid crystal display according to claim 27, wherein the heat dissipating layer contacts the substrate.

31. The liquid crystal display according to claim 27, wherein the electrode adhesive includes a soldering material.

32. The liquid crystal display according to claim 27, wherein the heat dissipating layer includes one of a soldering material, a conductive film and a conductive ball paste.

33. The liquid crystal display according to claim 27, wherein the substrate is ceramic.

34. The liquid crystal display according to claim 27, further comprising:
a lens surrounding the light emitting diode chip; and
a filling material filling an inside of the lens.
